(19) United States
(12) Patent Application Publication
(10) Pub. No.: US 2025/0274000 A1
(43) Pub. Date: Aug. 28, 2025

(54) SCHEDULING FOR MULTIPLE PRIMARY NODES

(71) Applicant: TEXAS INSTRUMENTS INCORPORATED, Dallas, TX (US)

(72) Inventors: Ariton E. XHAFA, Plano, TX (US); Minghua FU, Plano, TX (US); Jyothsna KUNDURU, Plano, TX (US); Jonathan NAFZIGER, Dallas, TX (US)

(21) Appl. No.: 18/647,353

(22) Filed: Apr. 26, 2024

Related U.S. Application Data
(60) Provisional application No. 63/556,469, filed on Feb. 22, 2024.

(51) Int. Cl. H02J 50/80; H04W 72/0446

(52) U.S. Cl. CPC H02J 50/80; H04W 72/0446

(57) ABSTRACT

A device comprises a transceiver that can wirelessly transmit and receive data, and a processor coupled to the transceiver. The processor can receive, from the transceiver and in a first time slot, first data transmitted by a first primary device; receive, from the transceiver and in a second time slot following the first time slot, second data transmitted by a second primary device; provide, to the transceiver and in a third time slot following the second time slot, third data to be transmitted on a first frequency to the first primary device, the third data including a battery cell status; and provide, to the transceiver in a fourth time slot following the second time slot, the third data to be transmitted to the second primary device, the transceiver configured to transmit the third data to the second primary device on a second frequency that is different than the first frequency.

### CROSS-REFERENCE TO RELATED APPLICATIONS

The present application claims priority to U.S. Provisional Patent Application No. 63/556,469, which was filed on Feb. 22, 2024, is entitled “SCHEDULING FOR MULTIPLE PRIMARY NODES,” and is hereby incorporated herein by reference in its entirety.

### BACKGROUND

Modern vehicles may include multiple battery cells. Sensors may monitor information associated with the cells, such as temperature, voltage, and other indicators of cell status and health, for vehicular safety and to ensure proper operation.

### SUMMARY

In examples, a device comprises a transceiver that can wirelessly transmit and receive data, and a processor coupled to the transceiver. The processor can receive, from the transceiver and in a first time slot, first data transmitted by a first primary device; receive, from the transceiver and in a second time slot following the first time slot, second data transmitted by a second primary device; provide, to the transceiver and in a third time slot following the second time slot, third data to be transmitted on a first frequency to the first primary device, the third data including a battery cell status; and provide, to the transceiver in a fourth time slot following the second time slot, the third data to be transmitted to the second primary device, the transceiver configured to transmit the third data to the second primary device on a second frequency that is different than the first frequency.

### BRIEF DESCRIPTION OF THE DRAWINGS

FIG. 1 is a schematic diagram of an automotive system including multiple primary and secondary devices configured to communicate using concurrent superframes, in accordance with various examples.

FIG. 2 is a block diagram of a system including multiple primary and secondary devices configured to communicate using concurrent superframes, in accordance with various examples.

FIGS. 3A-3B show a timing diagram illustrating a concurrent superframe communication protocol, in accordance with various examples.

FIG. 4 is a flow diagram of a method for wireless communications using concurrent superframes, in accordance with various examples.

FIG. 5 is a flow diagram of a method for wireless communications using concurrent superframes, in accordance with various examples.

FIG. 6 is a block diagram of a system configured to communicate using concurrent superframes, in accordance with various examples.

FIG. 7 is a block diagram of a system configured to communicate using concurrent superframes, in accordance with various examples.

### DETAILED DESCRIPTION

Some electronic devices operate using batteries. For example, electric vehicles include multiple battery cells that provide power to those vehicles. Because battery cells in an electronic device can provide large amounts of power, and further because the power provided by the battery cells may be vital to the operation of the electronic device, the electronic device may include a system to manage the battery cells.

Battery management systems (BMSs) may manage the battery cells of an electronic device in various ways. For example, a BMS may monitor the health (e.g., voltage, current, temperature) of battery cells in an electronic device. Further, the BMS may control various battery cells to manage the quantity of power provided by the battery cells and direct that power within the electronic device. Generally, a BMS includes multiple components, such as multiple battery modules and a controller to manage the battery modules. Each battery module, in turn, may couple to multiple battery cells and include a battery monitor to monitor those battery cells. Thus, the battery cells coupled to a battery module provide power to the electronic device; the battery monitor in the battery module monitors the health and operation of the battery cells in that battery module; and the controller communicates with the battery monitor to ensure the battery module and its cells operate properly. The controller may also communicate with the battery monitor to control the operation of the battery cells, such as to turn on, turn off, redirect, or otherwise balance the power provided by those battery cells.

BMSs may incorporate wireless technology to realize a wireless battery management system (WBMS). For example, a primary device contains or is coupled to a controller and a secondary device contains a battery module that controls multiple battery cells. The primary and secondary devices may communicate with each other wirelessly, for example using radio frequencies. In some protocols, a superframe is useful to facilitate wireless communications between the primary and secondary devices. A superframe is a wireless data communication scheme that facilitates the orderly communication of data between two or more wireless devices. In a superframe, the primary device first broadcasts a downlink (DL) communication (or packet) to multiple secondary devices. The secondary devices individually respond to the primary device with uplink (UL) communications (or packets) in a serial manner.

Systems relying on wireless communications can suffer from data losses due to a suboptimal communication environment. One reason for data losses is interference, which can arise from competing wireless signals (e.g., traffic in the same or similar frequency band), physical obstructions, or environmental conditions such as excessive moisture. Data may encounter obstacles that can degrade signal quality, leading to data loss. Additionally, wireless networks operate on shared bandwidth, meaning multiple devices contend for the same frequency spectrum, causing collisions and congestion. In some cases, multipath propagation, in which transmitted signals take multiple, different paths to reach the receiver, result in phase cancellations. These and other factors may contribute to packet loss in wireless communications.

Prior solutions have attempted to remediate such data losses by retransmitting packets in subsequent superframes. For example, a data packet intended for a primary device that was lost during transmission in a first superframe would have been retransmitted to the primary device in a second, subsequent superframe. This approach is time-consuming and inefficient. Further, this approach relies significantly on the integrity of the primary device. If the primary device ceases to function (e.g., due to power loss, malfunction, etc.), the system also ceases to function. Thus, these prior solutions are inadequate.

This disclosure describes various examples of a wireless communication technique to mitigate data losses by increasing data transmission redundancy using concurrent superframes. In particular, example systems (e.g., WBMSs) may include first and second primary devices coupled to a common battery controller. The first and second primary devices are configured for wireless communication. Example systems may further include first and second secondary devices, each of which is coupled to one or more battery cells, configured to monitor parameters of those battery cells (e.g., battery cell status), and configured to wirelessly communicate with other devices.

The primary and secondary devices described herein may be configurable to communicate wirelessly using a concurrent superframe protocol. Each superframe contains multiple time slots, and in each time slot, communications occur according to a schedule. For example, in a first time slot, device A may transmit synchronization data to device B, and in a second time slot, device B may transmit measurement data (e.g., battery status data) to device A. Superframes are generally transmitted serially, meaning one superframe after another. Superframes are not transmitted in parallel (i.e., concurrently). However, in the example systems described herein, superframes are transmitted in parallel (i.e., concurrently), and superframe slot communications are scheduled in a manner that significantly improves data redundancy and system robustness relative to systems that do not use the concurrent superframe scheme described herein.

In the concurrent superframe scheme, a first superframe and a second superframe occur concurrently, meaning that the first slot of the first superframe occurs at the same time as the first slot of the second superframe; the second slots of the first and second superframes occur concurrently, and so on. During the first slots of the first and second superframes, the aforementioned first primary device broadcasts synchronization data to the second primary device and to the first and second secondary devices. Each of the second primary device and the first and second secondary devices receives this synchronization data and uses the synchronization data to identify and store any clock differences between that device and the first primary device, and further uses such clock differences to facilitate synchronized, timely communication between the various devices. Similarly, during the second slots of the first and second superframes, the aforementioned second primary device broadcasts synchronization data to the first primary device and to the first and second secondary devices. Each of the first primary device and the first and second secondary devices receives this synchronization data and uses the synchronization data to identify and store any clock differences between that device and the second primary device, and further uses such clock differences to facilitate synchronized, timely communication between the various devices.

During the third slots of the first and second superframes (which, as described above, are concurrently occurring slots), the first secondary device transmits data to the first primary device and the second secondary device transmits data to the second primary device. The two transmissions may occur on different frequencies or channels that are adequately separated in the frequency domain to avoid interference. During the fourth and final slots of the first and second superframes (which, as described above, are concurrently occurring slots), the first secondary device transmits the same data it transmitted during the third slots, but this time, the first secondary device transmits the data to the second primary device. Similarly, during the fourth slots, the second secondary device transmits the same data it transmitted during the third slots, but this time, the second secondary device transmits the data to the first primary device. The two transmissions may occur on different frequencies or channels that are adequately separated in the frequency domain to avoid interference. In examples, all four transmissions in the third and fourth slots occur on different frequencies or channels to mitigate the risk of packet loss. By transmitting the same data twice during concurrent superframes to different primary devices on different frequencies, the likelihood that at least one instance of each datum will reach the targeted primary device (and, by extension, the battery controller coupled to the first and second primary devices) is substantially increased. In turn, the overall robustness of the system is increased. Furthermore, the use of temporally concurrent superframes increases both data throughput and performance relative to solutions in which temporally consecutive superframes are used, because, relative to consecutive superframes, the same amount of data is transmitted in half the time.

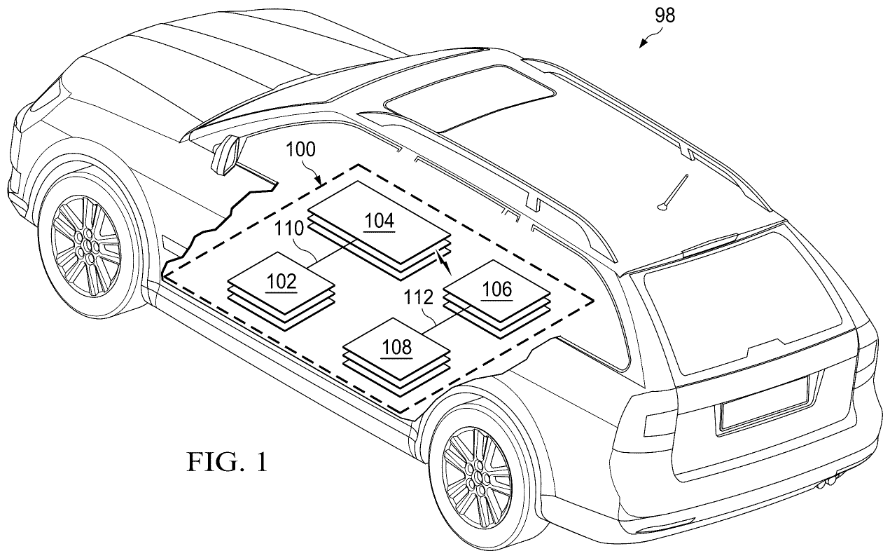

FIG. 1 is a schematic diagram of an automotive system 98 including multiple primary and secondary devices configured to communicate using concurrent superframes, in accordance with various examples. The system 98 may be a vehicle, such as an automobile, a watercraft, an aircraft, a spacecraft, or a military vehicle. The system 98 may also be a non-vehicular system that includes battery cells that are monitored. Further, the system 98 may be any type of system in which information is to be repeatedly communicated between wireless devices. Additional examples of the system 98 may include one or more of the following, in any combination: smartphones; laptop computers; desktop computers; tablets; notebooks; appliances; and entertainment devices. The remainder of this description assumes that the system 98 is an automobile, but the scope of this disclosure is not limited to automobiles or any other particular type of system. Furthermore, although the concurrent superframe scheme is described herein within the context of wireless battery management systems, the teachings of this disclosure may be extended to other types of systems, including home automation, industrial automation, and wireless sensor networks.

The example system 98 includes a wireless battery management system (WBMS) 100. The WBMS 100 may be positioned in any part of the automobile, but in some examples, the WBMS 100 is positioned in, on, or near a bottom part of a chassis of the automobile, such as below one or more seats of the automobile. The WBMS 100 may include one or more battery controllers 102 that oversees and controls the WBMS 100 (e.g., by load balancing among devices and determining whether to measure current, voltage, temperature, or other parameters of battery cells); one or more primary devices 104 coupled to the battery controllers 102 by way of one or more wired or wireless connections 110; one or more secondary devices 106; and one or more battery cells 108 coupled to the one or more secondary devices 106 by way of one or more wired or wireless connections 112. The primary devices 104 communicate wirelessly with the secondary devices 106 using a concurrent superframe protocol, as described herein.

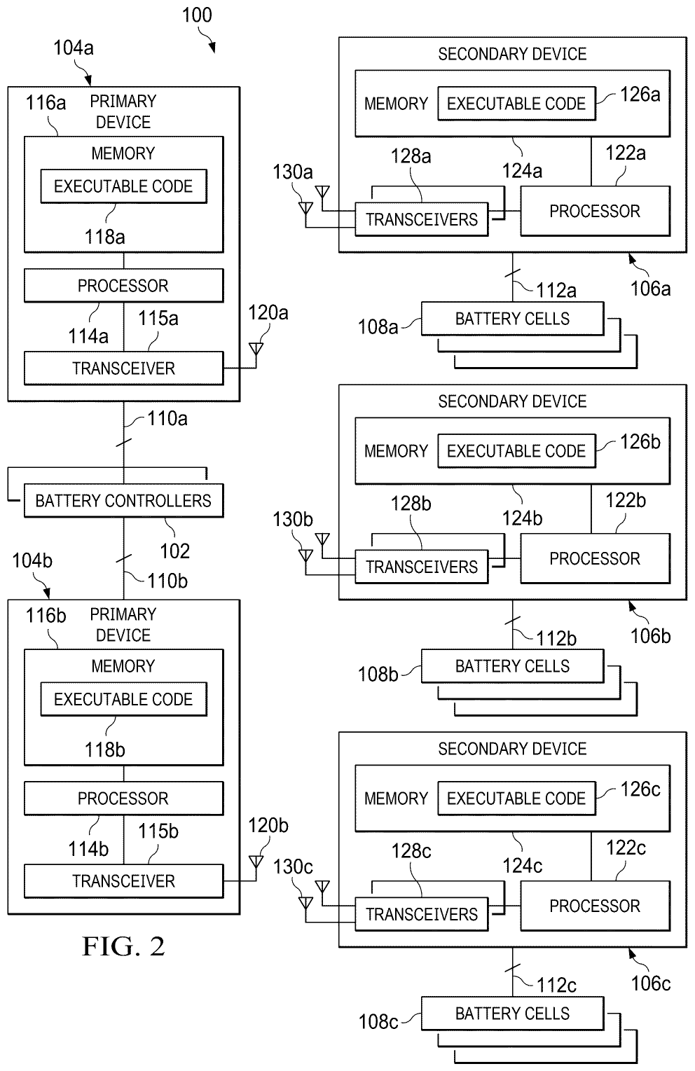

FIG. 2 is a block diagram of the WBMS 100, in accordance with various examples. The WBMS 100 may include one or more battery controllers 102 that are coupled to primary devices 104a and 104b by way of one or more wired or wireless connections 110a and 110b, respectively. The primary device 104a includes a processor 114a, a transceiver 115a coupled to the processor 114a, and memory 116a (e.g., random access memory (RAM), read-only memory (ROM)) coupled to the processor 114a. The memory 116a stores executable code 118a. The processor 114a, upon executing the executable code 118a, performs some or all of the actions attributed herein to the primary device 104a and/or to the processor 114a. An antenna 120a is coupled to the transceiver 115a and is configured to transmit signals to and receive signals from other devices in the WBMS 100. The primary device 104b includes a processor 114b coupled to a transceiver 115b and memory 116b (e.g., RAM or ROM). The memory 116b stores executable code 118b. The processor 114b, upon executing the executable code 118b, performs some or all of the actions attributed herein to the primary device 104b and/or the processor 114b. An antenna 120b is coupled to the transceiver 115b and is configured to transmit signals to and receive signals from other devices in the WBMS 100.

Any processors described herein may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

Further, any transceivers described herein may use the license-free 2.4 gigahertz (GHz) industrial, scientific, and medical (ISM) band from 2.4 GHz to 2.483 GHz, which is compliant with the Bluetooth Special Interest Group (SIG). Additionally or alternatively, the transceivers may use 2 megabits per second (Mbps) Bluetooth Low Energy (BLE) across the physical layer (PHY). The Open Systems Interconnection (OSI) model includes the PHY as a layer used for communicating raw bits over a physical medium. In examples described herein, the PHY is free space, which the WBMS 100 uses to wirelessly communicate between the various devices of the WBMS 100. In some examples, the transceivers described herein are instantiated by programmable circuitry executing RF instructions.

A secondary device 106a may include a processor 122a coupled to a memory 124a storing executable code 126a. The processor 122a, upon executing the executable code 126a, may perform some or all of the actions attributed herein to the secondary device 106a and/or the processor 122a. One or more transceivers 128a are coupled to the processor 122a, and one or more antennas 130a are coupled to the one or more transceivers 128a. The secondary device 106a is coupled to one or more battery cells 108a by way of one or more connections 112a.

A secondary device 106b may include a processor 122b coupled to a memory 124b storing executable code 126b. The processor 122b, upon executing the executable code 126b, may perform some or all of the actions attributed herein to the secondary device 106b and/or the processor 122b. One or more transceivers 128b are coupled to the processor 122b, and one or more antennas 130b are coupled to the one or more transceivers 128b. The secondary device 106b is coupled to one or more battery cells 108b by way of one or more connections 112b.

A secondary device 106c may include a processor 122c coupled to a memory 124c storing executable code 126c. The processor 122c, upon executing the executable code 126c, may perform some or all of the actions attributed herein to the secondary device 106c and/or the processor 122c. One or more transceivers 128c are coupled to the processor 122c, and one or more antennas 130c are coupled to the one or more transceivers 128c. The secondary device 106c is coupled to one or more battery cells 108c by way of one or more connections 112c.

The primary devices 104a, b of FIG. 2 may be collectively referred to herein as primary devices 104. Similarly, the secondary devices 106a-c may be collectively referred to herein as secondary devices 106, and so on. A similar convention may be used for any or all of the features depicted in the drawings.

The primary and secondary devices described herein (e.g., primary devices 104, secondary devices 106) may be implemented as a CC2662 and/or a BQ79616 made by TEXAS INSTRUMENTS INC.® of Dallas, TX. Additional example details of the CC2662 and BW79616 can be found in the datasheet entitled “CC2662R-Q1 SimpleLink™ Wireless BMS MCU,” revised July 2023, available at https://www.ti.eom/product/CC2662R-Q1, and the datasheet entitled “BQ79616-Q1, BQ79614-Q1, BQ79612-Q1 Functional Safety-Compliant Automotive 16S/14S/12S Battery Monitor, Balancer and Integrated Hardware Protector,” revised September 2022, available at https://www.ti.eom/product/BQ79616-Q1, each of which is incorporated by reference in its entirety.

Each of the secondary devices 106 is configured to monitor the status of respective battery cells 108 (e.g., the voltage being provided by the battery cells 108, the temperatures of battery cells 108). For example, each of the secondary devices 106 may include, or be coupled to, or communicate with one or more sensors configured to measure a variety of parameters associated with the battery cells 108. The sensors may relay the sensed data to the processors 122 of the secondary devices 106 by way of a universal asynchronous receiver/transmitter (UART) protocol or any other suitable protocol. Further, each of the secondary devices 106 is configured to communicate with both of the primary devices 104. For example, the secondary device 106a may communicate with the primary device 104a during one slot of a superframe, and the secondary device 106a may communicate with the primary device 104b during a different slot of the superframe. Alternatively, the secondary device 106a may communicate with the primary devices 104a, b simultaneously using different transceivers 128a. The secondary devices 106b, c may communicate with the primary devices 104a, b similarly to the secondary device 106a. In some examples, each of the secondary devices 106a-c is configured to communicate with one or more of the remaining secondary devices 106a-c. For instance, the secondary device 106a may be configured to communicate with one or more of the secondary devices 106b, c. The primary devices 104a, b also may communicate with the secondary devices 106a-c and with each other. For example, the primary device 104a may transmit data to one or more of the primary device 104b, the secondary device 106a, the secondary device 106b, or the secondary device 106c. The primary device 104b may operate similarly as the primary device 104a. The communications that are transmitted by the primary devices 104 may be received from one or more of the battery controllers 102. Similarly, the communications that are received by the primary devices 104 may be provided to one or more of the battery controllers 102.

The WBMS 100 as depicted in FIG. 2 is illustrative. In some examples, the WBMS 100 may include any number of primary devices, secondary devices, battery controllers, battery cells, other components, and wired and/or wireless connections between one or more of the foregoing. Any and all such variations are contemplated and included in the scope of this disclosure.

Additional examples of the components shown in FIGS. 1 and 2 can be found in the references incorporated by reference herein, including U.S. application Ser. No. 17/823,138, which is entitled, “Multiple Primary Nodes for Wireless Battery Management System Robustness,” was filed on Aug. 30, 2022, and is hereby incorporated herein by reference in its entirety.

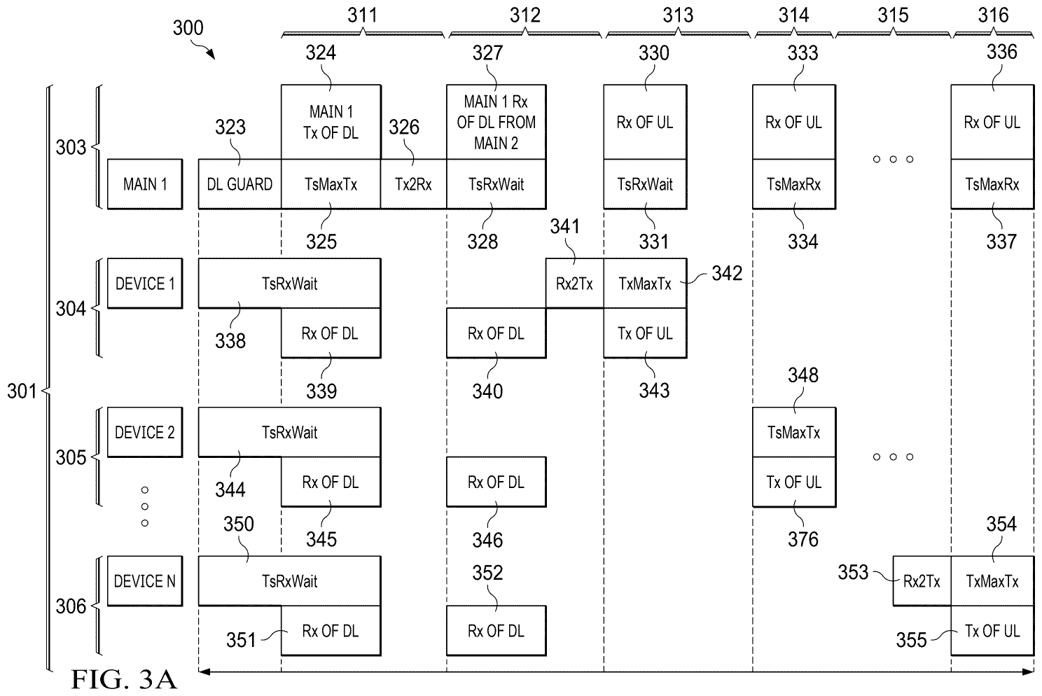

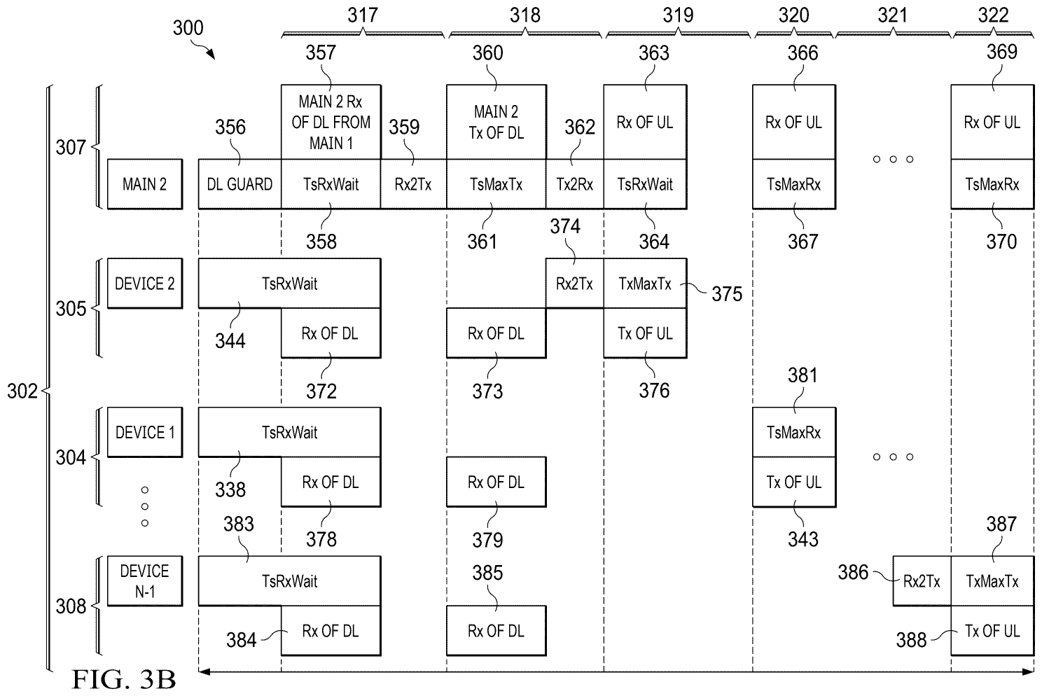

As described above, the various components of the WBMS 100 may communicate with each other according to a concurrent superframe protocol. A superframe interval is the time period during which a superframe occurs. Thus, “concurrent superframes” are multiple superframes that temporally overlap with each other such that they occur during a single superframe interval. FIGS. 3A-3B depict a timing diagram 300 illustrating a concurrent superframe communication protocol, such as may be implemented in the WBMS 100 of FIGS. 1 and 2, in accordance with various examples. Specifically, the timing diagram 300 includes a superframe 301 and a separate superframe 302 that occur concurrently during a single superframe interval. Each superframe includes multiple slots during which various devices in the WBMS 100 may transmit or receive data. For example, the superframe 301 includes slots 311-316, and the superframe 302 includes slots 317-322. Because the superframes 301, 302 are concurrent superframes, each of the slots 311-316 occurs concurrently with a respective slot 317-322, as shown.

Superframe 301 describes the behavior of devices 303-306. In the example shown, device 303 may be a primary device, such as the primary devices 104a, b. The remaining devices 304-306 may be secondary devices, such as the secondary devices 106a-c. For case of description, FIGS. 3A-3B label devices 303-306 as “main 1,” “device 1,” “device 2,” and “device n,” respectively. Superframe 302 describes the behavior of devices 304, 305, 307, and 308. In the example shown, device 307 may be a primary device, such as the primary devices 104a, b. The remaining devices 304, 305, and 308 may be secondary devices, such as the secondary devices 106a-c. For case of description, FIGS. 3A-3B label devices 307, 305, 304, and 308 as “main 2,” “device 2,” “device 1,” and “device n-1,” respectively.

Prior to the first slots 311 and 317, the superframes 301 and 302 enable DL guard transmission periods 323 and 356, respectively, which are useful to mitigate the risk of interference with other superframes that occurred prior to the superframes 301 and 302. At the time of the DL guard transmission periods 323 and 356, the secondary devices 304 (e.g., Node 1), 305 (e.g., Node 2), 306 (e.g., Node N), and 308 (e.g., Node N-1) enter receive modes 338, 344, 350, and 383 (TsRxWait), respectively, which means these secondary devices 304, 305, 306, and 308 are ready to receive transmissions from other device(s).

After the DL guard transmission periods 323 and 356 have expired, concurrent slots 311 and 317 begin. In slot 311, the primary device 303 (e.g., Main 1) broadcasts data 324 to the remaining devices 304-308. For example, the primary device 104a may broadcast data to the primary device 104b and the secondary devices 106a-c during slots 311 and 317. The data broadcast by the primary device 303 may include synchronization information that the receiving devices may use to synchronize their clocks with a clock of the primary device 303. For example, the data broadcast by the primary device 303 may include timestamp data that the receiving devices may use to synchronize their clocks with the clock of the primary device 303. The data broadcast by the primary device 303 may be referred to herein as downlinks. Numeral 325 indicates that, during transmission, the primary device 303 is in a transmission mode (TsMaxTx). At the same time, the secondary devices 304, 305, 306, and 308 are in receive modes 338, 344, 350, and 383, respectively (TsRxWait), and the primary device 307 (e.g., Main 2) is in a receive mode 358. During slots 311 and 317, the primary device 303 switches from a transmit mode to a receive mode, as numeral 326 indicates (Tx2Rx). Similarly, during slots 311 and 317, the primary device 307 switches from a receive mode to a transmit mode, as numeral 359 indicates (Rx2Tx). The secondary devices 304, 305, 306, and 308 remain in their receive modes.

Slots 312 and 318 occur concurrently following slots 311 and 317. During slots 312 and 318, the primary device 307 broadcasts data 360 to the remaining devices 303-306 and 308. The broadcast data may be similar to the synchronization data described above with respect to slots 311 and 317. During transmission of the data 360, the primary device 307 is in a transmission mode 361 (TsMaxTx), while the primary device 303 is in a receive mode 328. The secondary devices 304, 305, 306, and 308 are also in receive modes at this time. Accordingly, the primary device 303 and secondary devices 304, 305, 306, and 308 receive the data 360 broadcast by the primary device 307. For example, primary device 104b may broadcast synchronization data to the primary device 104a and to the secondary devices 106a-c. After transmission and receptions are complete in slots 312 and 318, the primary device 307 switches from a transmit mode to a receive mode as numeral 362 indicates (Tx2Rx), and secondary devices 304 and 305 switch from receive modes to transmit modes, as numerals 341 and 374 indicate (Rx2Tx).

Synchronization is complete after slots 312 and 318. Slots 313 and 319 occur concurrently following slots 312 and 318. During slots 313 and 319, multiple secondary devices simultaneously transmit data (e.g., status information collected from any of the battery cells 108a-c) to different primary devices 303, 307. For example, secondary device 304 may transmit data 343 to primary device 303, and, at the same time, secondary device 305 may transmit data 376 to primary device 307. To enable such transmissions, secondary device 304 is in transmit mode 342 (TsMaxTx), and secondary device 305 is in transmit mode 375 (TsMaxTx). To facilitate receptions of the transmitted data, primary device 303 is in receive mode 331 (TsRxWait) and primary device 307 is in receive mode 364 (TsRxWait). The data broadcast by secondary devices to primary devices may be referred to herein as uplinks.

Slots 314 and 320 occur concurrently following slots 313 and 319. During slots 314 and 320, secondary device 305 again transmits the same data 376 that the secondary device 305 transmitted during slot 319, and secondary device 304 again transmits the same data 343 that the secondary device 304 transmitted during slot 313. However, while secondary device 305 transmits the same data 376 in both slots 319 and 314, the destinations of the data 376 differ. During slot 319, secondary device 305 transmits the data 376 to primary device 307, while in slot 314, secondary device 305 transmits the data 376 to primary device 303. By transmitting data 376 during multiple slots and to different primary devices, secondary device 305 increases the likelihood that data 376 will be received by at least one of the primary devices 303 and 307, and, by extension, by a battery controller (e.g., battery controllers 102) that is coupled to primary devices 303 and 307. In this manner, the risk of data loss is mitigated. Similarly, while secondary device 304 transmits the same data 343 in both slots 313 and 320, the destinations of the data 343 differ. During slot 313, secondary device 304 transmits the data 343 to primary device 303, while in slot 320, secondary device 304 transmits the data 343 to primary device 307. By transmitting data 343 during multiple slots and to different primary devices, secondary device 304 increases the likelihood that data 343 will be received by at least one of the primary devices 303 and 307, and, by extension, by a battery controller (e.g., battery controllers 102) that is coupled to primary devices 303 and 307.

Slots 315 and 321 occur concurrently following slots 314 and 320. During slot 315, secondary device 306 switches from receive mode to transmit mode, as numeral 353 indicates (Rx2Tx). Similarly, during slot 321, secondary device 308 switches from receive mode to transmit mode, as numeral 386 indicates (Rx2Tx). Although a single slot 315 is depicted between slots 314 and 316 and a single slot 321 is depicted between slots 320 and 322, any number of slots n may be included between slots 314 and 316, and the same number of slots n may be included between slots 320 and 322.

Slots 316 and 322 occur concurrently following slots 315 and 321. During slot 316, secondary device 306 transmits data 355 to primary device 303 (while in receive mode 354, TsMaxTx). Although not expressly shown in FIGS. 3A-3B, secondary device 306 will have already transmitted data 355 to primary device 307 during a prior slot between slots 314/320 and slots 316/322. Thus, by transmitting data 355 twice during different time slots and to different primary devices, the risk of data loss is mitigated. Similarly, during slot 322, secondary device 308 transmits data 388 to primary device 307 (while in transmit mode 387, TsMaxTx). Although not expressly shown in FIGS. 3A-3B, secondary device 308 will have already transmitted data 388 to primary device 303 during a prior slot between slots 314/320 and slots 316/322. Thus, by transmitting data 388 twice during different time slots and to different primary devices, the risk of data loss is mitigated.

Redundant data transmissions need not occur in consecutive slots in all implementations of the techniques of this disclosure. For example, although timing diagram 300 depicts data 343 being transmitted in consecutive slots 313 and 320, in examples, data 343 may be transmitted in non-consecutive slots, such as in slots 313 and 322. (Transmission of the same data in non-consecutive time slots can be beneficial, for example, if the passage of additional time between the slots facilitates the removal of a condition or physical obstacle that was preventing successful reception of the data in the first of the two time slots.) The data transmission redundancy contemplated herein may be achieved so long as a particular datum is transmitted twice in a given superframe interval, to differing primary devices, and on different frequencies, meaning that the datum is transmitted to a first primary device, on a first frequency, and in a first superframe, and then again to a second primary device, on a second frequency different from the first frequency, and in a second superframe concurrent with the first superframe. Data redundancy also may be achieved even if the datum is transmitted twice to the same primary device. For example, a particular datum may be transmitted to a first primary device, on a first frequency, and in a first superframe, and then again to the same first primary device, on a second frequency different than the first frequency, and in a second superframe concurrent with the first superframe. Data redundancy also may be achieved even if the datum is transmitted twice on the same frequency. For example, a particular datum may be transmitted to a first primary device, on a first frequency, and in a first superframe, and then again to a second primary device, on the same first frequency, and in a second superframe that is concurrent with the first superframe. Data redundancy also may be achieved even if the datum is transmitted twice on the same frequency and to the same primary device. For example, a particular datum may be transmitted to a first primary device, on a first frequency, and in a first superframe, and then again to the same first primary device, on the same first frequency, but in a second superframe concurrent with the first superframe. Any and all such variations are contemplated and included in the scope of this disclosure.

To mitigate the risk of interference between simultaneous data transmissions, and further to mitigate the risk that same-data transmissions during separate slots fail to reach their intended destinations, secondary devices may use any of a variety of frequency hopping schemes. For example, with reference to timing diagram 300, in concurrent slots 313 and 319, the data 343 may be transmitted on a first frequency, and the data 376 may be simultaneously transmitted on a second frequency that is different than the first frequency. The first and second frequencies may be separated by at least 5 MHz or by at least 10 MHz (or, in terms of channels, the channels used are at least two channels, three channels, or five channels apart). Similarly, in concurrent slots 314 and 320, the data 343 and 376 may be simultaneously transmitted on first and second frequencies, respectively, with the first and second frequencies separated by at least 5 MHz or by at least 10 MHz (or, in terms of channels, the channels used are at least two channels, three channels, or five channels apart). Using different frequencies for simultaneous data transmission mitigates the risk of interference between the transmissions. Separation of at least 5 MHz or 10 MHz are examples of minimum separations; in some examples, the techniques of this disclosure may be implemented with minimum frequency separation other than 5 MHz or 10 MHz.

Different frequencies also may be useful across different slots. For example, in timing diagram 300, the data 343 may be transmitted on a first frequency in slot 313 and on a second frequency in slot 320 that is separated from the first frequency by at least 5 MHz or by at least 10 MHz (or, in terms of channels, the channels used are at least two channels, three channels, or five channels apart). Similarly, the data 376 may be transmitted on a first frequency in slot 319 and on a second frequency in slot 314 that is separated from the first frequency by at least 5 MHz or by at least 10 MHz (or, in terms of channels, the channels used are at least two channels, three channels, or five channels apart). To facilitate such separation in transmission frequencies, primary devices (e.g., primary devices 104) may transmit in their downlinks to secondary devices (e.g., secondary devices 106) specific frequency hopping schemes that are to be used during data transmissions. Furthermore, in some examples, secondary devices may receive and transmit data on similar frequencies. For example, with reference to timing diagram 300, the secondary device 304 may receive data 324 in slot 311 on a first frequency, receive data 360 in slot 318 on a second frequency, transmit data 343 in slot 313 on a third frequency, and transmit data 343 in slot 320 on a fourth frequency. In examples, the first and third frequencies may be the same. In examples, the first and fourth frequencies may be the same. In examples, the second and third frequencies may be the same. In examples, the second and fourth frequencies may be the same.

As just one example, a primary device can use a frequency hopping sequence with thirty-seven channels in the industrial, scientific, and medical (ISM) band. These bands have a random order in the hopping sequence and satisfy the condition that the adjacent frequencies are separated by 5 MHz or by 10 MHz. For example, the first hopping sequence is {2410, 2404, 2416, . . . }. The second hopping sequence can be a different version of the first hopping sequence, except shifted by one position. Hence, the second hopping sequence is {2404, 2416, . . . 2410}, preserving a 5 MHz separation or a 10 MHz separation for the primary device operating in a first frequency (2410) and another primary device operating in a second frequency (2404). After each hop, the first and second frequencies remain 5 MHz apart or 10 MHz apart.

In addition to transmitting frequency hopping schemes in downlinks, primary devices (e.g., primary devices 104) may transmit scheduling instructions to secondary devices (e.g., secondary devices 106) in downlinks. For example, one or more primary devices may be configured to instruct secondary devices regarding the specific slots of a given superframe(s) and the specific channels and/or frequencies in which the secondary devices are to transmit uplinks to the primary devices. Primary devices may change the scheduling instructions with each superframe interval, or, alternatively, may maintain the same scheduling instructions for multiple consecutive superframe intervals. Primary devices may also transmit additional information to the secondary devices, such as acknowledgements for uplink transmissions from a previous superframe, an indication when the next superframe may begin, an adaptive frequency hopping countdown, etc. In some examples, the primary devices do not transmit scheduling instructions to the secondary devices in the downlinks. Instead, some or all devices in the WBMS 100 are preprogrammed with a defined schedule that is to be followed for some or all superframe intervals, unless instructed otherwise by one or more primary devices. Alternatively, primary devices may transmit a single downlink with scheduling instructions that are to be followed in all superframe intervals until further notice. A battery controller (e.g., battery controller 102) may provide the primary devices with scheduling instructions that the primary devices may then disseminate to the remaining devices of the WBMS 100.

The secondary devices transmit data to the primary devices according to the scheduling instructions and channel and/or frequency instructions provided by the primary devices or preprogrammed into the secondary devices. After receiving a downlink transmission from a primary device, a secondary device may parse the transmission to determine the slots and channels or frequencies in which the secondary device is scheduled to uplink information to the primary device(s). In some examples, information for how to parse the downlink transmission may be provided to the secondary device during a WBMS network formation process.

In some examples, secondary devices include multiple transceivers. For example, as shown in FIG. 2, secondary device 106a includes multiple transceivers 128a. In examples, the multiple transceivers 128a of FIG. 2 may simultaneously (in the same slot) transmit data 343 twice using different transceivers 128a. Such simultaneous transmissions may occur on the same or different frequencies. The transmissions may be directed to the same or different primary devices 104 (e.g., both the secondary and primary devices may have multiple transceivers communicating simultaneously on different frequencies). Thus, the same level of redundancy that is achieved by single-transceiver secondary devices transmitting the same data in different slots can be achieved by multi-transceiver secondary devices in a more compressed timeframe.

In some examples, primary devices (e.g., primary devices 104a, b) may be spatially positioned apart from each other (e.g., 6.25 cm (half the wavelength at 2.4 GHz) apart). Providing a threshold amount of distance between the primary devices increases the likelihood that environmental obstacles hindering the successful transmission of data packets to one primary device will not likewise hinder the successful transmission of data packets to the other primary device.

In some examples, uplink data transmissions may be performed in consecutive slots of concurrent superframes to accommodate large amounts of data that could not otherwise be transmitted in a single uplink. Such techniques are described in U.S. patent application Ser. No. 18/227,821, which is entitled “Methods and Apparatus to Determine Communication Schedules for Wireless Battery Systems,” was filed on Jul. 28, 2023, and is hereby incorporated herein by reference in its entirety. All subject matter described in U.S. patent application Ser. No. 18/345,636, which is entitled, “Hierarchical Wireless Battery Management System” and was filed on Jun. 30, 2023, is hereby incorporated herein by reference in its entirety.

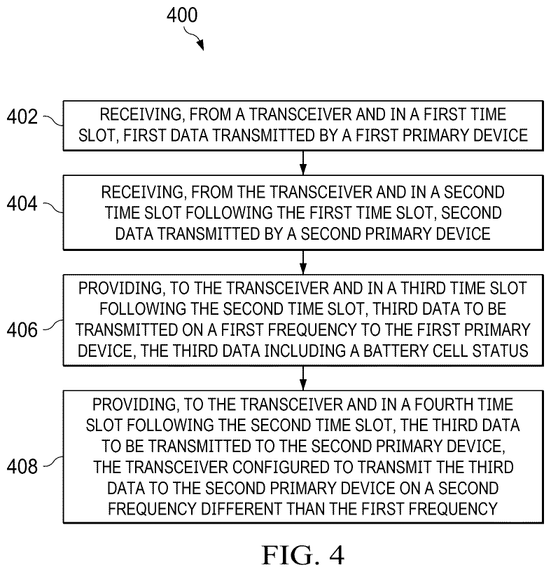

FIG. 4 is a flow diagram of a method 400 for wireless communications using concurrent superframes, in accordance with various examples. In examples, a secondary device (e.g., secondary device 106a, b, or c) performs the method 400 using the example concurrent superframe scheme depicted in FIGS. 3A-3B. Thus, the method 400 is described herein from the perspective of example secondary device 106a and with reference to FIGS. 2-4.

The method 400 includes receiving, from a transceiver and in a first time slot, first data transmitted by a first primary device (402). For example, the processor 122a of secondary device 106a may receive, by way of a transceiver 128a and during slot 311 (which occurs concurrently with slot 317), first data transmitted by the primary device 104a. This data may, for instance, be the data 324, which, as described above, is broadcast by the primary device 303 (such as primary device 104a) to the remaining primary and secondary devices 304-308 (which may include secondary device 106a).

The method 400 includes receiving, from the transceiver and in a second time slot following the first time slot, second data transmitted by a second primary device (404). For example, the processor 122a of secondary device 106a may receive, by way of a transceiver 128a and during slot 312 (which occurs concurrently with slot 317), second data transmitted by the primary device 104b. This data may, for instance, be the data 360, which, as described above, is broadcast by the primary device 307 (such as primary device 104b) to the remaining primary and secondary devices 303-306 and 308 (which may include secondary device 106a).

The method 400 includes providing, to the transceiver and in a third time slot following the second time slot, third data to be transmitted on a first frequency to the first primary device, the third data including a battery cell status (406). For example, the processor 122a of secondary device 106a may transmit, by way of a transceiver 128a and during slot 313 (which occurs concurrently with slot 319), third data to the first primary device. This data may, for instance, be the data 343, which, as described above, is transmitted by secondary device 304 (such as secondary device 106a) to primary device 303 (such as primary device 104a). The data may include battery cell status, such as status information (e.g., voltage, current, temperature) pertaining to the battery cells 108a. The transceiver 128a may transmit the third data on a particular frequency that differs from the frequency on which other data transmitted during the third slot (e.g., slot 313) in transmitted. In examples, the difference in frequencies is at least 5 MHz or at least 10 MHz.

The method 400 includes providing, to the transceiver and in a fourth time slot following the second time slot, the third data to be transmitted to the second primary device, the transceiver configured to transmit the third data to the second primary device on a second frequency different than the first frequency (408). For example, the processor 122a of secondary device 106a may transmit, by way of a transceiver 128a and during slot 314 (which occurs concurrently with slot 320), the same third data that was transmitted in the third time slot of step 406. However, in the fourth slot of step 408, the third data (e.g., data 343) is transmitted to a different primary device (e.g., primary device 307, such as primary device 104b) and on a different frequency than the frequency used in step 406 (e.g., with the transmission frequencies in steps 406 and 408 being separated by at least 5 MHz or by at least 10 MHz).

By transmitting the same data on different frequencies and in different slots, secondary device 106a raises the likelihood that the data will reach the intended destination. The risk of data loss is mitigated.

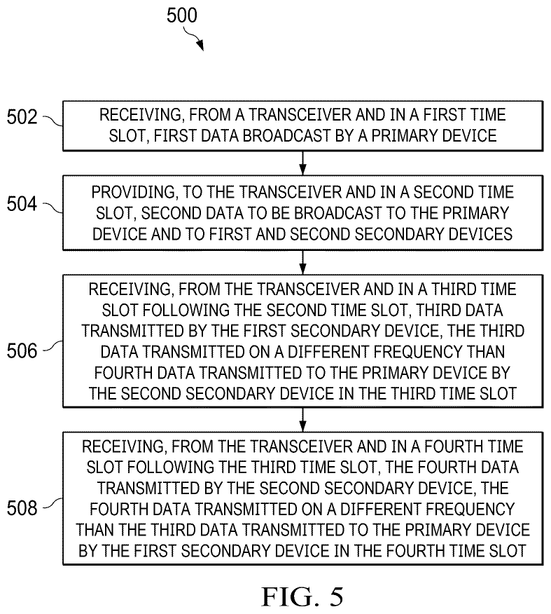

FIG. 5 is a flow diagram of a method 500 for wireless communications using concurrent superframes, in accordance with various examples. In examples, a primary device (e.g., primary device 104a or b) performs the method 500 using the example concurrent superframe scheme depicted in FIGS. 3A-3B. Thus, the method 500 is described herein from the perspective of example primary device 104b.

The method 500 includes receiving, from a transceiver and in a first time slot, first data broadcast by a primary device (502). For example, the processor 114b of primary device 104b (e.g., primary device 307) may receive, from the transceiver 115b and in slot 311, first data (e.g., data 324) broadcast by primary device 104a (e.g., primary device 303).

The method 500 includes providing, to the transceiver and in a second time slot, second data to be broadcast to the primary device and to first and second secondary devices (504). For example, the processor 114b of primary device 104b (e.g., primary device 307) may provide to the transceiver 115b and in slot 313, second data (e.g., data 360) to be broadcast to the primary device (e.g., primary device 303, 104a) and to first and second secondary devices (e.g., secondary devices 304, 305, such as secondary devices 106a, b).

The method 500 includes receiving, from the transceiver and in a third time slot following the second time slot, third data transmitted by the first secondary device, the third data transmitted on a different frequency than fourth data transmitted to the primary device by the second secondary device in the third time slot (506). For example, the processor 114b of primary device 104b (e.g., primary device 307) may receive, from the transceiver 115b and in slot 313, third data (e.g., data 376) transmitted on a different frequency than fourth data (e.g., data 343) transmitted to the primary device 303 (e.g., primary device 104a) by the second secondary device (e.g., secondary device 304, 106b). The data 376 may have been transmitted by secondary device 305 (e.g., secondary device 106a). The frequencies on which data 343 and 376 are transmitted in the third time slot are separated by at least 5 MHz or by at least 10 MHz.

The method 500 includes receiving, from the transceiver and in a fourth time slot following the third time slot, the fourth data transmitted by the second secondary device, the fourth data transmitted on a different frequency than the third data transmitted to the primary device by the first secondary device in the fourth time slot (508). For example, the processor 114b of primary device 104b (e.g., primary device 307) may receive, from the transceiver 115b and in slot 314, the fourth data (e.g., data 343) transmitted by the second secondary device (e.g., secondary device 304, 106b). The third data (e.g., data 376) is also transmitted during slot 314 to secondary device 305 (e.g., secondary device 106a). The third and fourth data are transmitted on differing frequencies during slot 314, with the frequencies separated by at least 5 MHz or by at least 10 MHz.

In this manner, data 343 is transmitted twice (e.g., once during slot 313, and once during slot 320), and data 376 is transmitted twice (e.g., once during slot 319, and once during slot 314). By transmitting each data twice in different slots of different, concurrent superframes (i.e., twice during the same superframe interval) and on different frequencies, the likelihood of at least one of the two data transmissions reaching the battery controllers 102 is significantly increased.

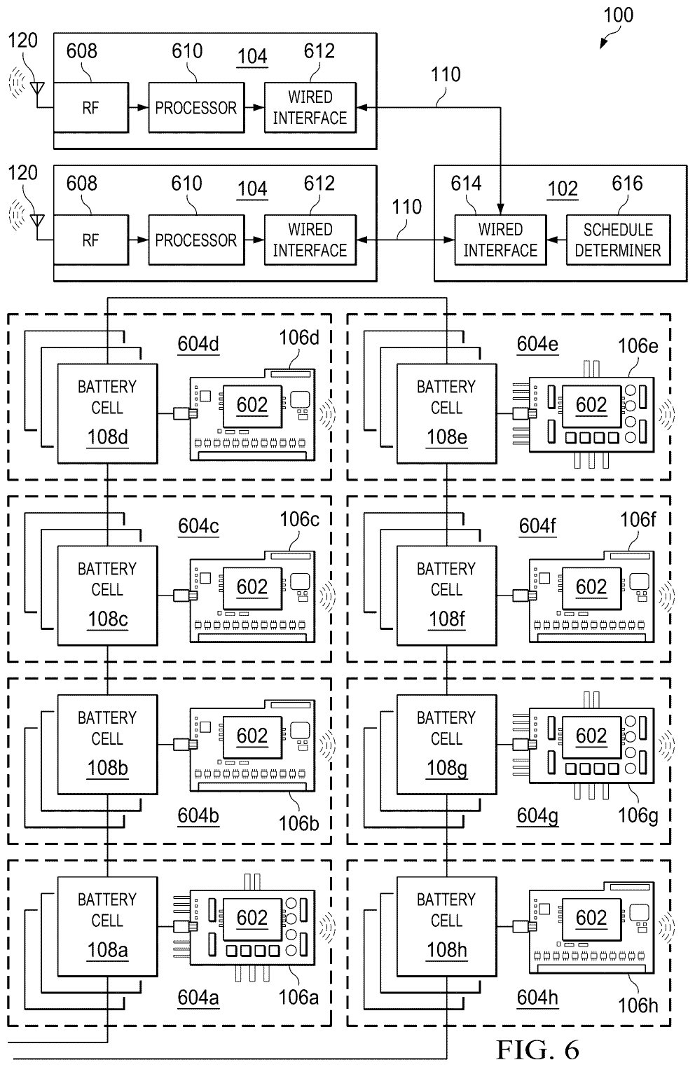

FIG. 6 is a block diagram of an example implementation of the WBMS 100 of FIGS. 1 and 2. The WBMS 100 of FIG. 6 is configured to operate in accordance with the concurrent superframe scheme described herein, such as that described with reference to FIGS. 3-5. The WBMS 100 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the WBMS 100 of FIG. 6 may be instantiated by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The example block diagram of FIG. 6 includes the battery controller 102, primary device 104 (e.g., primary device 104a or 104b), secondary devices 106a-106h (which correspond to secondary devices 106), and battery cells 108a-108h (which correspond to battery cells 108). The scope of this disclosure is not limited to any particular number of each type of device illustrated in FIG. 6. For example, while two instances of primary device 104 are expressly shown, the WBMS 100 of FIG. 6 may include any number of primary devices 104.

Each of the secondary devices 106 includes example schedule requester circuitry 202. As used herein, a secondary device 106a and its corresponding battery cell 108a are collectively referred to as a battery module 204a. Accordingly, the battery modules 204a-204h collectively form battery modules 204. The primary device 104 includes an example antenna 206, example radio frequency (RF) transceiver 208, an example processor 210 and example wired interface circuitry 212. The battery controller 102 includes example wired interface circuitry 214 and example schedule determiner circuitry 216. While FIG. 6 shows eight battery modules 204 and one battery controller 102, in other examples, the WBMS 100 includes any number of battery modules and battery controllers. For example, WBMS 100 may include two or more battery controllers, where a first set of the secondary devices are assigned to communicate with a first battery controller, and a second set of the secondary devices are assigned to communicate with a second battery controller. The first and second sets of secondary devices may or may not overlap.

The battery modules 204 wirelessly communicate with the primary device 104 using concurrent superframes. That is, a first superframe containing a first set of communications occurs at the same time as a second superframe containing a second set of communications. Within a given battery module 204a, the schedule requester circuitry 202 determines whether a transmission regarding the corresponding battery cell 108a should be made in an upcoming set of concurrent superframes. The schedule requester circuitry 202 may determine whether to make a transmission based on factors that include status and performance of the corresponding battery cell 108a.

The schedule requester circuitry 202 optionally requests to be included on a schedule for an upcoming superframe based on the result of the determination and in accordance with the teachings of this disclosure. Accordingly, the battery modules 204 do not request to make a transmission in an upcoming superframe every time an opportunity to make a request is available. The schedule requester circuitry 202 may provide additional information to the battery controller 102 when requesting a transmission in an upcoming superframe. The schedule requester circuitry 202 may also request a specific number of requested time slots, request a specific duration of uplink time, and/or request a specific data size to uplink (e.g., a specific number of blocks, bytes, or bits), etc. Alternatively, the request sent by the schedule requester circuitry 202 may indicate only that a corresponding battery module 204A is requesting more time for transmission, without any specifics about the requested time duration, number of time slots, or uplink size.

In the example of FIG. 6, each instance of the schedule requester circuitry 202 is implemented within the secondary devices 106. In other examples, one or more instances of the schedule requester circuitry 202 are implemented elsewhere within the respective battery modules 204. In some examples, the schedule requester circuitry 202 is instantiated by programmable circuitry executing schedule requester instructions.

Within the primary device 104, the radio frequency (RF) transceiver 208 communicates wirelessly with the secondary devices 106 via the antenna 206. The RF transceiver 208 may use the license-free 2.4 gigahertz (GHz) industrial, scientific, and medical (ISM) band from 2.4 GHz to 2.483 GHz, which is compliant with the Bluetooth Special Interest Group (SIG). Additionally or alternatively, the RF transceiver 208 may use 2 megabits per second (Mbps) Bluetooth Low Energy (BLE) across the physical layer (PHY). The Open Systems Interconnection (OSI) model includes the PHY as a layer used for communicating raw bits over a physical medium. In examples described herein, the PHY is free space, which the wireless battery management system 100 uses to wirelessly communicate between the primary device 104 and the secondary devices 106. In some examples, the RF transceiver 208 is instantiated by programmable circuitry executing RF instructions. The remaining transceivers in WBMS 100 may be configured to operate similarly as the RF transceiver 208.

Within the primary device 104, the processor 210 both interprets the contents of data received by the primary device 104 and determines the contents of data to be transmitted by the primary device 104. In doing so, the processor 210 helps establish communication between the battery modules 204 and the battery controller 102. The processor 210 may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

Within the primary device 104, the wired interface circuitry 212 sends and receives communications with the battery controller 102 via the wired connection 110. The wired interface circuitry 212 may implement any suitable hardware components, including but not limited to terminals, pins, interconnects, etc., to implement wired communications. Similarly, within the battery controller 102, the wired interface circuitry 214 sends and receives communications with the primary device 104 via the wired connection 110. The wired interface circuitry 214 may implement any suitable hardware components to implement wired communications. In examples, the wired interfaces 212, 214 may be replaced by transceivers or other circuitry suitable to facilitate wireless communications between the primary device 104 and the battery controller 102.

The schedule determiner circuitry 216 determines different communication schedules for different superframes. The schedule determiner circuitry 216 adjusts a schedule and/or creates new schedules for superframes based on the transmission request transmitted by the multiple instances of the schedule requester circuitry 202.

In the example of FIG. 6, the schedule determiner circuitry 216 is implemented within the battery controller 102. In other examples, the schedule determiner circuitry 216 is implemented within the primary device 104 or elsewhere within the WBMS 100. In some examples, the schedule determiner circuitry 216 is instantiated by programmable circuitry executing schedule determiner instructions.

The battery modules 204 are heterogeneous in the sense that the design, manufacture, capabilities, and/or performance of a first battery module may differ from that of a second battery module. For example, in FIG. 6, battery cells 108a, 108b, 108d store a larger amount of charge than battery cells 108c, 108e-108h. Furthermore, the amount of charge stored in battery cells 108a, 108b, 108d is nonuniform. In an additional example, FIG. 6 illustrates the secondary devices 106a, 106e, 106g implemented by a first type of programmable circuitry, and secondary devices 106b-106d, 106f, 106h implemented by a different type of programmable circuitry. While the example FIG. 6 illustrates variance in battery capacity and type of programmable circuitry, in practice, the battery modules 204 may include other types of differences.

In some examples, the heterogeneity of the WBMS 100 causes some battery modules to seek communication with the battery controller 102 more frequently than other battery modules. Some battery modules may additionally or alternatively transmit different types of information within a superframe than other battery modules. For example, the battery module 204a may seek to report a storage capacity measurement when the battery module 204b seeks to report an error code. The battery controller 102 enables such diverse forms of communication by obtaining requests for transmissions sent by the battery modules 204 and determining a schedule for each superframe.

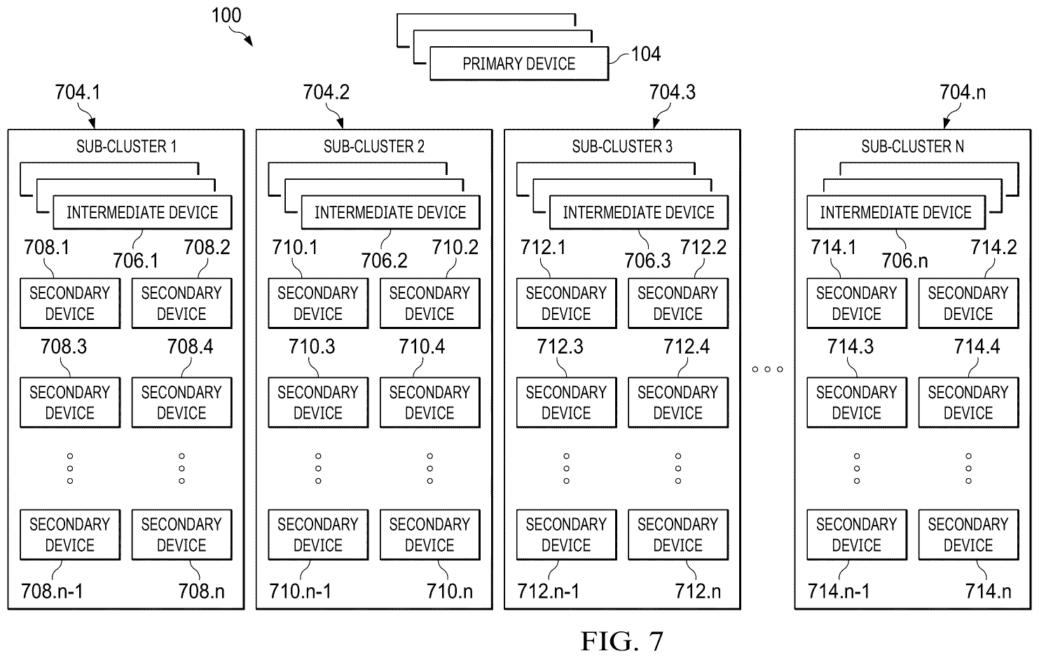

FIG. 7 is a block diagram of another example WBMS 100. The architecture of the example WBMS 100 in FIG. 7 includes a layer of intermediate devices between the primary and secondary devices, thus facilitating scale in especially large or complex systems. The example WBMS 100 of FIG. 7 includes one or more primary devices 104 and multiple sub-clusters 704.1-704.N (collectively referred to herein as sub-clusters 704). Although FIG. 7 shows an example WBMS 100 with a single primary device 104, the sub-cluster architecture shown in FIG. 7 may be implemented in a WBMS 100 with multiple primary devices (e.g., WBMS 100 shown in FIG. 2). The WBMS 100 shown in FIG. 7 may be configurable to implement the scheduling described herein with respect to FIGS. 3-5 with the intermediate devices 706 communicating with multiple primary devices.

The sub-cluster 704.1 includes one or more intermediate devices 706.1 and multiple secondary devices 708.1-708.N (collectively referred to herein as secondary devices 708). The sub-cluster 704.2 includes one or more intermediate devices 706.2 and multiple secondary devices 710.1-710.N (collectively referred to herein as secondary devices 710). The sub-cluster 704.3 includes one or more intermediate devices 706.3 and multiple secondary devices 712.1-712.N (collectively referred to herein as secondary devices 712). The sub-cluster 704.N includes one or more intermediate devices 706.N and multiple secondary devices 714.1-714.N (collectively referred to herein as secondary devices 714).

In operation, each of the secondary devices shown in FIG. 7 collects data, such as the battery cell status data described above, and provides the data to a corresponding intermediate device 706. For example, each of the secondary devices 708 collects data and transmits the data to first and second intermediate devices 706.1. These transmissions occur according to the concurrent superframe scheme described herein, such as with reference to FIGS. 1-5. Thus, for instance, the first and second intermediate devices 706.1 may broadcast downlink synchronization information during first and second slots of concurrent superframes, as described above. The secondary devices 708 may receive the broadcast information and use the broadcast information to synchronize communications with the first and second intermediate devices 706.1. Thereafter, during the concurrent superframes, each of the secondary devices 708 may transmit its respective data twice, once in one slot to the first intermediate device 706.1, and again in another slot to the second intermediate device 706.1, with both transmissions occurring on different frequencies. In this way, the first and second intermediate devices 706.1 are substantially likely to receive at least one instance of the data from each of the secondary devices 708. Each of the sub-clusters 704 operates in a similar manner.

After the intermediate devices 706 of each sub-cluster 704 has received the data from respective secondary devices, the intermediate devices 706 transmit the data to the primary devices 104 using the concurrent superframe scheme described herein. For example, in first and second slots of concurrent superframes, first and second primary devices 104 may broadcast downlink synchronization information to the intermediate devices 706, which the intermediate devices 706 may use to synchronize communications with the first and second primary devices 104. Thereafter, during the concurrent superframes, each of the intermediate devices 706 may transmit respective data twice, once in one slot to the first primary device 104, and again in another slot to the second primary device 104, with both transmissions possibly occurring on different frequencies. In this way, the first and second primary devices 104 are substantially likely to receive at least one instance of the data from each of the intermediate devices 706. The concurrent superframe scheme described herein may be scaled to any number of wireless devices in a WBMS, or any other system besides a WBMS in which robust wireless communications are useful. For example, three or more primary devices 104 may be used, in which case a given intermediate device 706 may transmit the same data to the three or more primary devices 104 during different slots and on different frequencies. In some examples in which three or more primary devices 104 may be used, a first intermediate device 706 may transmit data to first and second primary devices 104 in different slots and on different frequencies, while a second intermediate device 706 transmits different data to second and third primary devices 104 in different slots and on different frequencies. Furthermore, the concepts described herein may be extended to any number of concurrent superframes.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A device, comprising:
a transceiver configured to wirelessly transmit and wirelessly receive data; and
a processor coupled to the transceiver, the processor configured to:
receive, from the transceiver and in a first time slot, first data transmitted by a first primary device;
receive, from the transceiver and in a second time slot following the first time slot, second data transmitted by a second primary device;
provide, to the transceiver and in a third time slot following the second time slot, third data to be transmitted on a first frequency to the first primary device, the third data including a battery cell status; and
provide, to the transceiver and in a fourth time slot following the second time slot, the third data to be transmitted to the second primary device, the transceiver configured to transmit the third data to the second primary device on a second frequency that is different than the first frequency.

2. The device of claim 1, wherein the third and fourth time slots are consecutive time slots.

3. The device of claim 1, wherein the third and fourth time slots are non-consecutive time slots.

4. The device of claim 1, wherein the first data or the second data specifies a timing of the third time slot or the fourth time slot.

5. The device of claim 1, wherein the device is configured to store a timing of the third time slot or the fourth time slot prior to receipt of the first data and prior to receipt of the second data.

6. The device of claim 1, wherein the first and second frequencies are separated by at least 5 MHz.

7. The device of claim 1, wherein the first and second time slots are consecutive time slots.

8. The device of claim 1, wherein the processor is configured to receive the first data in the first time slot on a third frequency that is the same as the first frequency.

9. The device of claim 1, wherein the processor is configured to receive the second data in the second time slot on a third frequency that is the same as the second frequency.

10. The device of claim 1, wherein the processor is configured to receive the first data in the first time slot on a third frequency that is the same as the second frequency.

11. The device of claim 1, wherein the processor is configured to receive the second data in the second time slot on a third frequency that is the same as the first frequency.

12. A wireless battery management system (WBMS), comprising:
a first primary device configured to wirelessly broadcast first data during a first time slot; and
a secondary device configured to:
wirelessly receive the first data during the first time slot;
wirelessly receive second data broadcasted by a second primary device during a second time slot after the first time slot;
wirelessly transmit third data to the first primary device during a third time slot after the second time slot, the third data comprising a battery cell status; and
wirelessly transmit the third data to the second primary device during a fourth time slot after the second time slot.

13. The system of claim 12, wherein the first and second time slots are consecutive time slots.

14. The system of claim 12, wherein the first and second data together include timing information for the third and fourth time slots.

15. The system of claim 12, wherein the secondary device is configured to store timing information for the third and fourth time slots prior to receiving the first data and prior to receiving the second data.

16. The system of claim 12, wherein the secondary device is configured to transmit the third data in the third time slot on a first frequency and the third data in the fourth time slot on a second frequency different from the first frequency using a frequency hopping scheme.

17. The system of claim 12, wherein the secondary device is a first secondary device, the system further comprising a second secondary device configured to transmit fourth data to the first primary device during the fourth time slot.

18. The system of claim 17, wherein the second secondary device is configured to transmit the fourth data to the second primary device during the third time slot.

19. A non-transitory computer readable medium storing instructions which, when executed by a processor, cause the processor to:
during a first time slot, receive first data wirelessly transmitted by a first primary device to the processor and to a secondary device;
during a second time slot, cause wireless transmission of second data to the first primary device simultaneous with transmission of third data from the secondary device to a second primary device, the second and third data comprising battery cell status; and
during a third time slot, cause wireless transmission of the second data to the second primary device simultaneous with transmission of the third data from the secondary device to the first primary device.

20. The medium of claim 19, wherein the instructions cause the processor to transmit the second data to the first primary device and to the second primary device on different frequencies.
